(19) United States
(12) Patent Application Publication
(10) Pub. No.: US 2014/0006986 A1
(43) Pub. Date: Jan. 2, 2014

(54) Responsive graphical user interface

(71) Applicant: T. Michael Cappucio, Palm Beach Gardens, FL (US)

(72) Inventor: T. Michael Cappucio, Palm Beach Gardens, FL (US)

(21) Appl. No.: 13/923,018

(22) Filed: Jun. 20, 2013

Related U.S. Application Data
(60) Provisional application No. 61/661,902, filed on Jun. 20, 2012.

(51) Int. Cl. G06F 3/0482

(52) U.S. Cl. CPC G06F 3/0482
USPC 715/765

(57) ABSTRACT

Disclosed is a user interface that is compatible with every Mac and PC platform as well as every Web Browser including: Microsoft Internet Explorer, Google Chrome, Mozilla Firefox, Apple's Safari and Opera and works with every eco-system built for computers, tables and mobile phones. The user interface is for computing devices wherein location and access to the menu can be positioned to instantly adjust to the preference of the user. In the preferred embodiment, the interface is for use with a portable tablet computer a handheld device. In the preferred embodiments the interface works with a touch-sensitive display and/or a graphical user interface (GUI) with sets of instructions stored in the memory for performing multiple functions. The user interacts with the GUI primarily through finger contacts and gestures on the touch-sensitive surface.

### REFERENCE TO RELATED APPLICATIONS

In accordance with 37 C.F.R. 1.76, a claim of priority is included in an Application Data Sheet filed concurrently herewith. Accordingly, the present invention claims priority under 35 U.S.C. §§119(e), 120, 121, and/or 365(c) to U.S. Provisional Patent Application No. 61/661,902, entitled “NAVIGATION INTERFACE”, filed Jun. 20, 2012. The contents of which the above referenced application is incorporated herein by reference.

### FIELD OF THE INVENTION

This invention relates generally to electronic devices and in particular to a responsive graphical user navigation interface for electronic devices.

### BACKGROUND OF THE INVENTION

The use of graphical user interfaces has increased significantly in recent years and has made the use of certain electronic devices easier to use. In graphical user interfaces, menus are used to locate files and folders that are graphically represented as displays wherein the user interface allows information to be manipulated in accordance with user inputs.

With the advent of the smart devices, menu placement is critical to allow ease of access by the consumer and may be used to enhance or supplement graphical user interfaces. For purposes of this invention, smart devices include electronic devices such as Blackberry and iPhone cellular phones, and tablets such as the Apple iPad and Android tablet.

Current operation of such devices is not intuitive to all device users. For instance, some users prefer drop down menus while others prefer a display of a navigation menu at all times. If a user is familiar with an application the need to display a menu at all times is not helpful and will take up valuable display screen real estate. However, if a user is not familiar with an application then the need for a navigation menu is constant. In either event, the display and removal of menus can be tedious and creates a significant cognitive burden on a user. In addition, existing methods take longer than necessary thereby wasting energy which is becoming increasing important as such devices are battery-operated and any wasted time results in to depletion of power. Further, if such applications are performed on-line, unless the user has an unlimited communication access the additional time can also result in a significant financial impact.

Accordingly, there is a need for a navigation interface for computing devices that provides for faster and more efficient navigation menus.

### SUMMARY OF THE INVENTION

The instant invention is an interface that works with every eco-system built for computers, tables and mobile phones. It is compatible with Mac and PC platform as well as every Web Browser including: Microsofts Internet Explorer, Google Chrome, Mozilla Firefox, Apple's Safari and Opera. The interface can be used on Apple IOS, Microsoft IOS, Blackberry IOS, Android IOS and all versions thereto.

The navigation interface is for computing devices wherein location and access to the menu can be positioned to instantly adjust to the preference of the user, automatically upon rotation of the device. The interface is for use with a portable tablet computer or a handheld device having self adjusting rotation. In the preferred embodiments the interface works with a touch-sensitive display and/or a graphical user interface (GUI) with sets of instructions stored in the memory for performing multiple functions. The user interacts with the GUI primarily through finger contacts and gestures on the touch-sensitive surface. By way of illustration, the navigation menus can work with application that include image editing, drawing, presenting, word processing, website creating, disk authoring, spreadsheet making, game playing, telephoning, video conferencing, e-mailing, instant messaging, workout support, digital photographing, digital videoing, web browsing, digital music playing, and/or digital video playing. Executable instructions for performing these functions may be included in a computer readable storage medium or other computer program product configured for execution by one or more processors.

By use of the automation navigation menu, electronic devices are provided with faster, more efficient methods and interfaces for accessing menus, thereby increasing the effectiveness, efficiency, and user satisfaction with such devices.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE DRAWINGS

FIG. 1 is a portrait a view of an iPad,

FIG. 2 is a portrait view of an iPad including a drop down menu;

FIG. 3 is a landscape view of an iPad illustrated menu positioning on the left side of the screen;

FIG. 4 is a landscape view of an iPad having a menu in combination with a drop down menu; and

FIG. 5 is a flow diagram of the instant invention.

### DETAILED DESCRIPTION OF THE PREFERRED EMBODIMENT

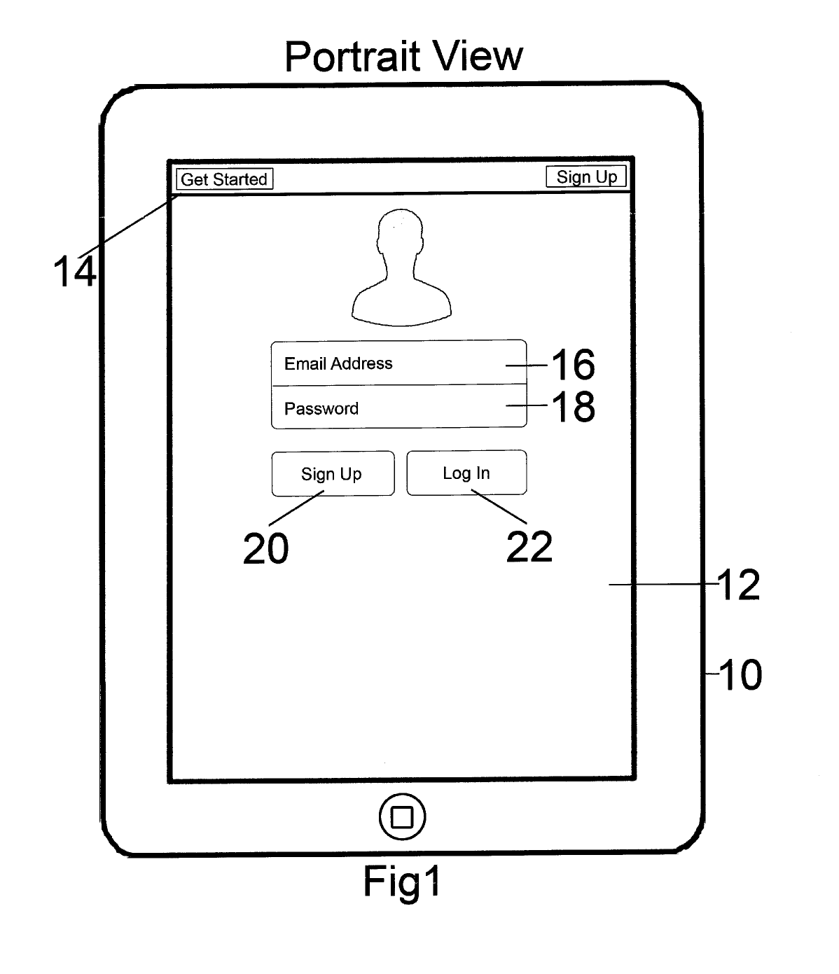

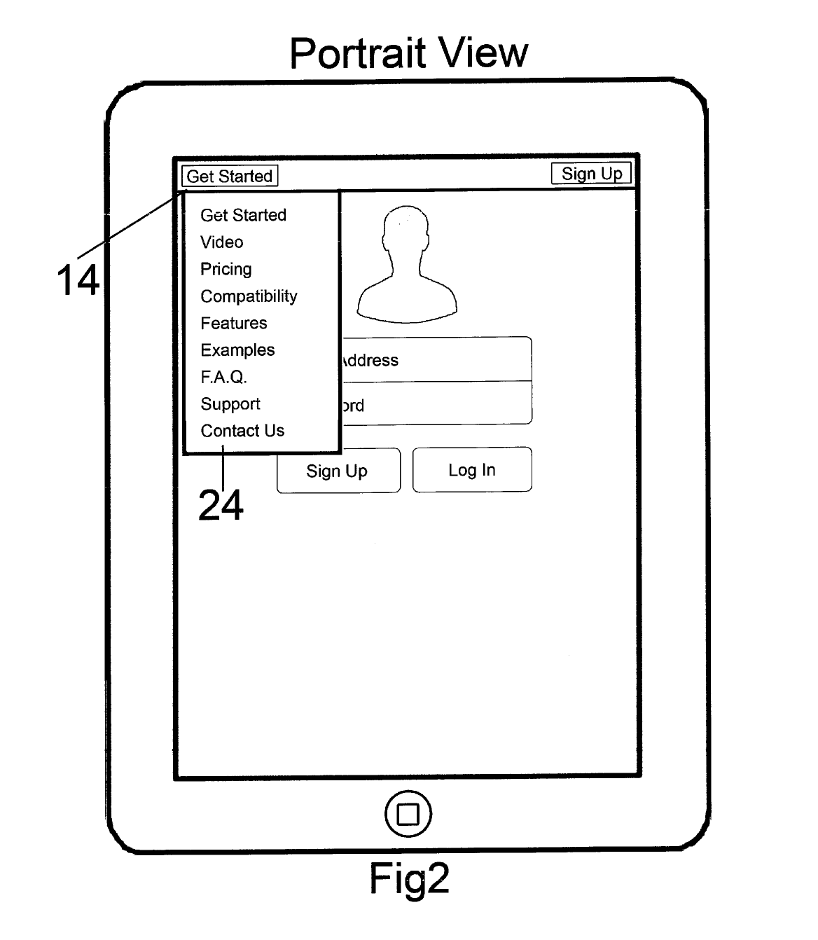

Referring to FIG. 1 set forth is an iPad 10 having a display screen 12 shown in a portrait view wherein the height of the display screen exceeds the width. By way of illustration set forth is the applicant's web site application having a single menu position 14 located along the top left hand corner of the display screen 12. A user of the application can be classified as being either familiar with the application or an infrequent user, either of which seeks to access the web site creation application quickly by entering an e-mail address 16 and password 18 to either sign-up 20 or log-in 22. Referring to FIG. 2, if the user is not familiar with all aspects of the application, the user can depress the drop down menu 14 which sets forth a menu display 24 where the user can obtain information such as: get started, video, pricing, comparability, features, examples, F.A.Q., support, or contact us. In this embodiment the user takes advantage of the rotation mechanism found in such devices like the iPad and iPhone thereby avoiding the use of menus concerning subject areas that the user is already familiar with.

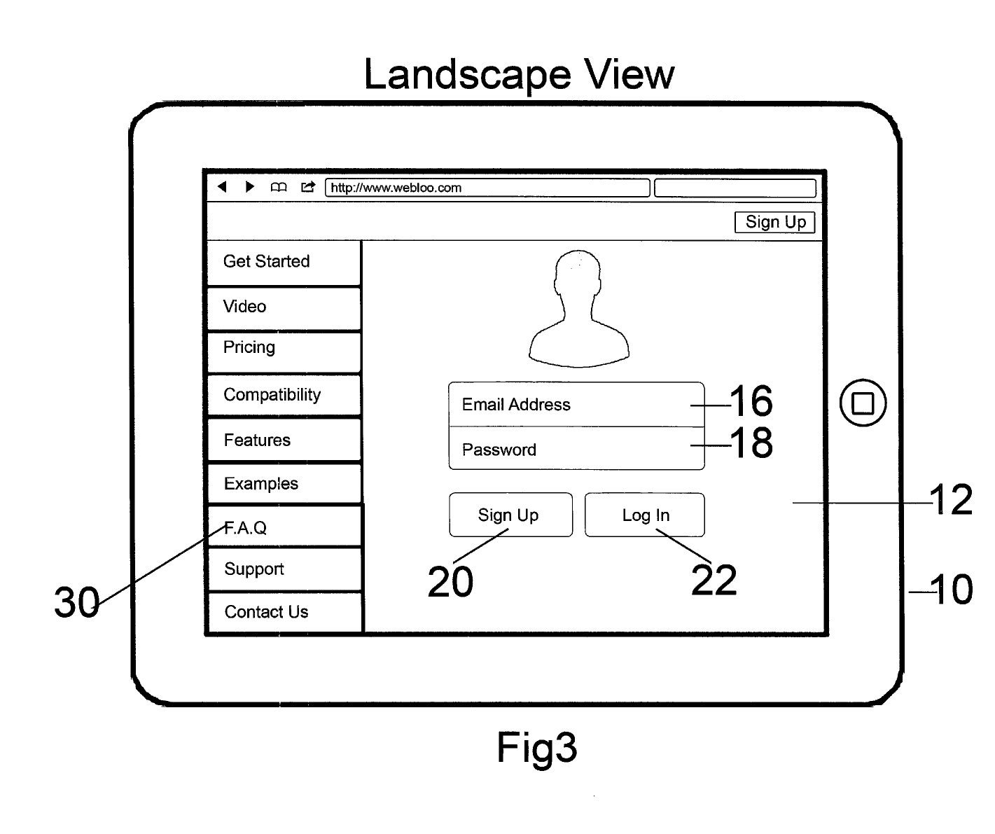

Referring to FIG. 3 set forth is a landscape illustration of the iPad 10 having a display screen 12 set forth in a horizontal position wherein the height is less than the width. By way of example the applicant's web site building application is again displayed where the user may immediately insert the address 16 and password 18 for purposes of sign-up 20 or long-in 22. In this illustration the menu is fully displayed along the left hand side 30 of the display screen 12. In this example the user is deemed unfamiliar with the website application and highly likely the user will be need instructional menus throughout the navigating of the application. The use of the landscape mode for a user that is not familiar with the application expedites the use as an applicant does not need to pull a menu down for each and every item of a menu driven application. Such an interface allows the user to choose either the portrait or landscape view to enhance the efficiency of the smart device. A more advanced user may employ the portrait view while a newer user will employ the landscape field. In this manner the navigation system is maintained on the left hand corner and is always visible while in the landscape view while in the portrait view a drop down menu can be accessed but is not always visible until called upon.

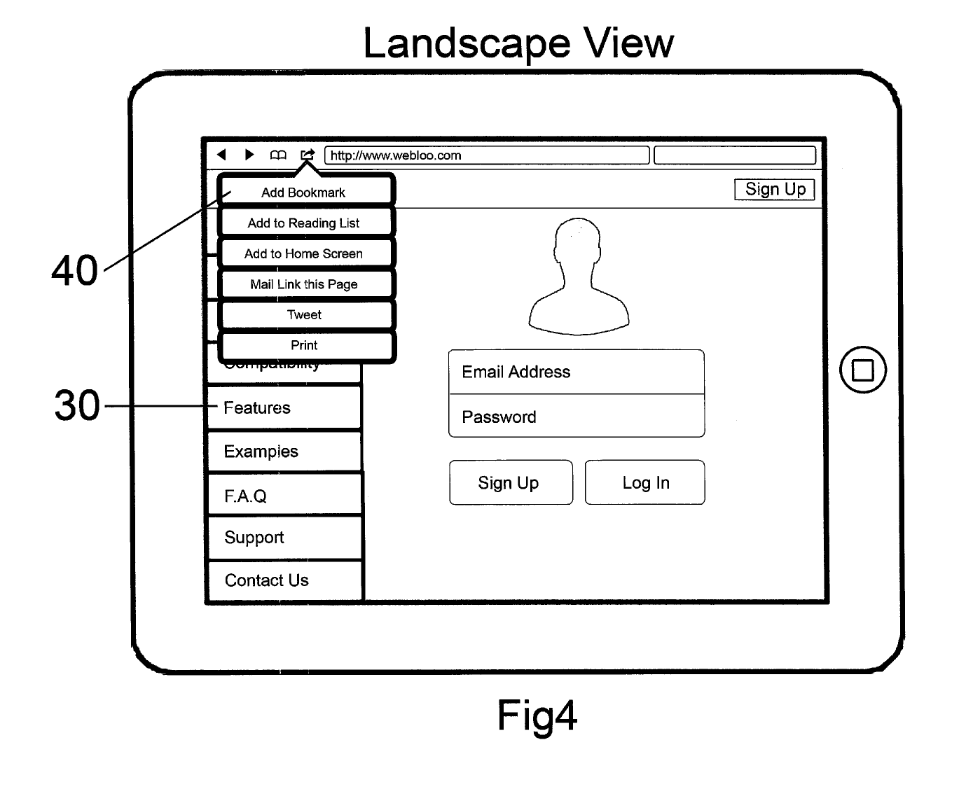

FIG. 4 illustrations the iPad 10 having the navigation menu 30 on the left hand side of the screen but further illustrates that the interface does not affect the normal drop down menus 40 that are part of the operating system and used for basic commands, not particular to the instant application, such as adding of a bookmark or printing of the screen. The applicants interface being directed to and limited to providing an interface for smart devices that can rotate between a portrait view and landscape view for maintaining of the navigation screen in a particular location when the device is placed in landscape view. It should be noted that in many instances a landscape view is always maintained such as a lap top computer where an additional width allows the maintenance of the navigation screen without interfering with the size of the display. Similarly a cellular phone that has a portrait view without a tilt and rotation, the interface would maintain the portrait view with drop down screens as a lack of width would inhibit the use of a fully displayed navigation menu. The interface can be used with all smart devices and fixed computers allowing the developer to make their application display two different displays while in the portrait view versus the landscape view promoting efficiency.

Menu location can be written in HTML 5, Java script and CSS or php. By way of example, placement of a menu may be in accordance with the following CSS code. The navigation system includes a set of computer program instructions stored in the memory of a computing device and executed by said computing device in order to perform actions of: calculating a portrait rotation position for placement of a menu icon on a display screen; and calculating a landscape rotation position for placement of a menu on the display screen, wherein the landscape rotation position is visually rotated from the portrait rotation position. The application is compatible with Mac and PC platform as well as every Web Browser including: Microsofts Internet Explorer, Google Chrome, Mozilla Firefox, Apple's Safari and Opera. The interface can be used on Apple IOS, Microsoft IOS, Blackberry IOS, Android IOS and all versions thereto.

The computing device identifies a rotation type and calculates an orientation as an absolute orientation in response to the rotation type, wherein the orientation is independent of the first orientation based upon rotating the computing device a fixed number of degrees.

```
/* Main */
  height: 100%;
  background: #eee url(../images/sidebar.png) repeat-y top
left;
  width: 100%;
  min-width: 320px;
  margin: 0 auto;
  overflow: auto;
  position: relative;
  /* background: url(../images/noise.png); */
/* Header */
  width: 100%;
  height: 50px;
  display: block;
  background: rgb(54,77,132); /* Old browsers */
  background: -moz-linear-gradient(top, rgba(54,77,132,1)
0%, rgba(22,30,68,1) 100%); /* FF3.6+ */
  background: -webkit-gradient(linear, left top, left bottom,
color-stop(0%,rgba(54,77,132,1)), color-
stop(100%,rgba(22,30,68,1))); /* Chrome,Safari4+ */
  background: -webkit-linear-gradient(top, rgba(54,77,132,1)
0%,rgba(22,30,68,1) 100%); /* Chrome10+,Safari5.1+ */
  background: -o-linear-gradient(top, rgba(54,77,132,1)
0%,rgba(22,30,68,1) 100%); /* Opera 11.10+ */
  background: -ms-linear-gradient(top, rgba(54,77,132,1)
0%,rgba(22,30,68,1) 100%); /* IE10+ */
  background: linear-gradient(top, rgba(54,77,132,1)
0%,rgba(22,30,68,1) 100%); /* W3C */
  filter: progid:DXImageTransform.Microsoft.gradient(
startColorstr=‘#364d84’, endColorstr=‘#161e44’,GradientType=0 );
/* IE6-9
.signup-button
  float: right;
  margin: 10px 10px 0 0;
  padding: 7px 17px;
  -webkit-border-radius: 5px;
  -moz-border-radius: 5px;
  border-radius: 5px;
  background: rgb(127,190,66); /* Old browsers */
  background: -moz-linear-gradient(top, rgba(127,190,66,1)
0%, rgba(77,135,2,1) 100%); /* FF3.6+ */
  background: -webkit-gradient(linear, left top, left bottom,
color-stop(0%,rgba(127,190,66,1)), color-
stop(100%,rgba(77,135,2,1))); /* Chrome,Safari4+ */
  background: -webkit-linear-gradient(top,
rgba(127,190,66,1) 0%,rgba(77,135,2,1) 100%); /*
Chrome10+,Safari5.1+ */
  background: -o-linear-gradient(top, rgba(127,190,66,1)
0%,rgba(77,135,2,1) 100%); /* Opera 11.10+ */
  background: -ms-linear-gradient(top, rgba(127,190,66,1)
0%,rgba(77,135,2,1) 100%); /* IE10+ */
  background: linear-gradient(top, rgba(127,190,66,1)
0%,rgba(77,135,2,1) 100%); /* W3C */
  filter: progid:DXImageTransform.Microsoft.gradient(
startColorstr=‘#7fbe42’, endColorstr=‘#4d8702’,GradientType=0 );
/* IE6-9
.signup-button:hover
  background: rgb(116,175,61); /* Old browsers */
  background: -moz-linear-gradient(top, rgba(116,175,61,1)
0%, rgba(59,119,2,1) 100%); /* FF3.6+ */
  background: -webkit-gradient(linear, left top, left bottom,
color-stop(0%,rgba(116,175,61,1)), color-
stop(100%,rgba(59,119,2,1))); /* Chrome,Safari4+ */
  background: -webkit-linear-gradient(top,
rgba(116,175,61,1) 0%,rgba(59,119,2,1) 100%); /*
Chrome10+,Safari5.1+ */
  background: -o-linear-gradient(top, rgba(116,175,61,1)
0%,rgba(59,119,2,1) 100%); /* Opera 11.10+ */
  background: -ms-linear-gradient(top, rgba(116,175,61,1)
0%,rgba(59,119,2,1) 100%); /* IE10+ */
  background: linear-gradient(top, rgba(116,175,61,1)
0%,rgba(59,119,2,1) 100%); /* W3C */
  filter: progid:DXImageTransform.Microsoft.gradient(
startColorstr=‘#74af3d’, endColorstr=‘#3b7702’,GradientType=0 );
/* IE6-9
/* Side Navigation */
  width: 299px;
  float: left;
  border-right: 1px solid #333;
ul#nav li
  position: relative;
ul#nav li a
  display: block;
  padding: 15px 20px;
  background-color: #fff;
  border-bottom: 1px solid #ddd;
  font-family: Arial, sans-serif;
  font-size: 16px;
  line-height: 26px;
  color: #333;
  text-decoration: none;
  -webkit-transition: all 0.2s linear 0s;
  -moz-transition: all 0.2s linear 0s;
  -o-transition: all 0.2s linear 0s;
  transition: all 0.2s linear 0s;
/* Content */
  width: 70%;
  padding: 4% 0;
  float: left;
  text-align: center;
#content h1
  margin-bottom: 15px;
  font: bold 32px/32px Arial, sans-serif;
  color: #4d8702;
#content p
  width: 420px;
  margin: 0 auto;
  padding: 0 7%;
  font: 16px/22px Arial, sans-serif;
  color: #707070;
#content form
  width: 420px;
  margin: 20px auto 60px auto;
input.mail
  width: 380px;
  margin: 0;
  padding: 20px;
  border: 1px solid #888;
  -moz-border-radius-topleft: 15px;
  -moz-border-radius-topright: 15px;
  -moz-border-radius-bottomright: 0px;
  -moz-border-radius-bottomleft: 0px;
  -webkit-border-radius: 15px 15px 0px 0px;
  border-radius: 15px 15px 0px 0px;
  -webkit-box-shadow: inset 0px 3px 7px 0px rgba(0, 0, 0,
0.2);
  -moz-box-shadow: inset 0px 3px 7px 0px rgba(0, 0, 0, 0.2);
  box-shadow: inset 0px 3px 7px 0px rgba(0, 0, 0, 0.2);
  font: 24px Arial, sans-serif;
  color: #aaa;
input.password
  width: 380px;
  margin: 0;
  padding: 20px;
  border-top: 0;
  border-right: 1px solid #888;
  border-bottom: 1px solid #888;
  border-left: 1px solid #888;
  -moz-border-radius-topleft: 0px;
  -moz-border-radius-topright: 0px;
  -moz-border-radius-bottomright: 15px;
  -moz-border-radius-bottomleft: 15px;
  -webkit-border-radius: 0px 0px 15px 15px;
  border-radius: 0px 0px 15px 15px;
  -webkit-box-shadow: inset 0px −2px 4px 0px rgba(0, 0, 0,
0.1);
  -moz-box-shadow: inset 0px −2px 4px 0px rgba(0, 0, 0, 0.1);
  box-shadow: inset 0px −2px 4px 0px rgba(0, 0, 0, 0.1);
  font: 24px Arial, sans-serif;
  color: #aaa;
input.button
  width: 200px;
  padding: 20px;
  border: 1px solid #888;
  -webkit-border-radius: 15px;
  -moz-border-radius: 15px;
  border-radius: 15px;
  background: rgb(245,245,245); /* Old browsers */
  background: -moz-linear-gradient(top, rgba(245,245,245,1)
0%, rgba(224,224,224,1) 100%); /* FF3.6+ */
  background: -webkit-gradient(linear, left top, left bottom,
color-stop(0%,rgba(245,245,245,1)), color-
stop(100%,rgba(224,224,224,1))); /* Chrome,Safari4+ */
  background: -webkit-linear-gradient(top,
rgba(245,245,245,1) 0%,rgba(224,224,224,1) 100%); /*
Chrome10+,Safari5.1+ */
  background: -o-linear-gradient(top, rgba(245,245,245,1)
0%,rgba(224,224,224,1) 100%); /* Opera 11.10+ */
  background: -ms-linear-gradient(top, rgba(245,245,245,1)
0%,rgba(224,224,224,1) 100%); /* IE10+ */
  background: linear-gradient(top, rgba(245,245,245,1)
0%,rgba(224,224,224,1) 100%); /* W3C */
  filter: progid:DXImageTransform.Microsoft.gradient(
startColorstr=‘#f5f5f5’, endColorstr=‘#e0e0e0’,GradientType=0 );
/* IE6-9
  font: bold 24px Arial, sans-serif;
  color: #555;
  cursor: pointer;
input. button: hover
  background: rgb(249,249,249); /* Old browsers */
  background: -moz-linear-gradient(top, rgba(249,249,249,1)
0%, rgba(231,231,231,1) 100%); /* FF3.6+ */
  background: -webkit-gradient(linear, left top, left bottom,
color-stop(0%,rgba(249,249,249,1)), color-
stop(100%,rgba(231,231,231,1))); /* Chrome,Safari4+ */
  background: -webkit-linear-gradient(top,
rgba(249,249,249,1) 0%,rgba(231,231,231,1) 100%); /*
Chrome10+,Safari5.1+ */
  background: -o-linear-gradient(top, rgba(249,249,249,1)
0%,rgba(231,231,231,1) 100%); /* Opera 11.10+ */
  background: -ms-linear-gradient(top, rgba(249,249,249,1)
0%,rgba(231,231,231,1) 100%); /* IE10+ */
  background: linear-gradient(top, rgba(249,249,249,1)
0%,rgba(231,231,231,1) 100%); /* W3C */
  filter: progid:DXImageTransform.Microsoft.gradient(
startColorstr=‘#f9f9f9’, endColorstr=‘#e7e7e7’,GradientType=0 );
/* IE6-9
```

For tablets the code would be as follows:

```
form#select-menu
  display: block;
  float: left;
  margin: 10px;
  padding: 4px;
  background: -moz-linear-gradient(top,
rgba(125,126,125,0.3)
0%, rgba(14,14,14,0.3) 100%); /* FF3.6+ */
  background: -webkit-gradient(linear, left top, left
bottom, color-stop(0%,rgba(125,126,125,0.3)), color-
stop(100%,rgba(14,14,14,0.3))); /* Chrome,Safari4+ */
  background: -webkit-linear-gradient(top,
rgba(125,126,125,0.3) 0%,rgba(14,14,14,0.3) 100%); /*
Chrome10+,Safari5.1+
  background: -o-linear-gradient(top,
rgba(125,126,125,0.3) 0%,rgba(14,14,14,0.3) 100%); /* Opera
11.10+ */
  background: -ms-linear-gradient(top,
rgba(125,126,125,0.3) 0%,rgba(14,14,14,0.3) 100%); /* IE10+ */
  background: linear-gradient(top,
rgba(125,126,125,0.3) 0%,rgba(14,14,14,0.3) 100%); /* W3C */
  border-radius: 7px;
  -moz-border-radius: 7px;
  -webkit-border-radius: 7px;
  -moz-box-shadow: 0px 1px 0px rgba(255,255,255,0.3),
inset 0px 1px 0px rgba(0,0,0,0.2);
  -webkit-box-shadow: 0px 1px 0px rgba(255,255,255,0.3),
inset 0px 1px 0px rgba(0,0,0,0.2);
```

For mobile phones the code would be as follows:

```
#user
    width: 104px;
#content h1
    margin-bottom: 15px;
    font: bold 24px/24px Arial, sans-serif;
#content p
    width: 275px;
    font: 14px/18px Arial, sans-serif;
    color: #707070;
#content form
    width: 315px;
    margin: 20px auto 40px auto;
input.mail, input.password
    width: 280px;
    padding: 15px;
    font: 20px Arial, sans-serif;
input.mail
    -moz-border-radius-topleft: 12px;
    -moz-border-radius-topright: 12px;
    -moz-border-radius-bottomright: 0px;
    -moz-border-radius-bottomleft: 0px;
    -webkit-border-radius: 12px 12px 0px 0px;
    border-radius: 12px 12px 0px 0px;
input.password
    -moz-border-radius-topleft: 0px;
    -moz-border-radius-topright: 0px;
    -moz-border-radius-bottomright: 12px;
    -moz-border-radius-bottomleft: 12px;
    -webkit-border-radius: 0px 0px 12px 12px;
    border-radius: 0px 0px 12px 12px;
#forgot-password
    width: 310px;
    padding: 10px 0;
    font: 14px Arial, sans-serif;
#forgot-password a
    margin-right: 10px;
    font-weight: bold;
    color: #364d84;
    text-decoration: none;
#forgot-password a:hover
    text-decoration: underline;
input.button
    width: 150px;
    padding: 15px;
    -webkit-border-radius: 12px;
    -moz-border-radius: 12px;
    border-radius: 12px;
    font: bold 20px Arial, sans-serif;
For html the code would be as follows:
<head>
  <title>Build a Website in Minutes</title>
  <meta charset=“utf-8” />
  <meta name=“description” content=“” />
  <meta name=“viewport” content=“width=device-width, initial-
scale=0.95, maximum-scale=0.95” />
  <meta name=“apple-mobile-web-app-capable” content=“yes” />
  <link rel=“shortcut icon” href=“images/favicon.ico” />
  <link rel=“apple-touch-startup-image”
href=“images/startup.png”>
  <link rel=“apple-touch-icon-precomposed” href=“images/touch-
icon-iphone.png”>
  <link rel=“apple-touch-icon-precomposed” sizes=“72×72”
href=“images/touch-icon-ipad.png”>
  <link rel=“apple-touch-icon-precomposed” sizes=“114×114”
href=“images/touch-icon-iphone4.png”>
  <link rel=“image_src” href=“images/fb.png”/>
  <link rel=“stylesheet” href=“css/main.css” />
  <link rel=“stylesheet” href=“css/homescreen.css” />
  <script type=“text/jayascript”>
var addToHomeConfig = {
  touchIcon:true,
</script>
  <script src=“js/homescreen.js”
type=“text/javascript”></script>
  <script>
    window.addEventListener(“load”,function( ) {
      setTimeout(function( ){
      // Hide the address bar!
      window.scrollTo(0, 1);
  </script>
© Cappucio, all rights reserved.
```

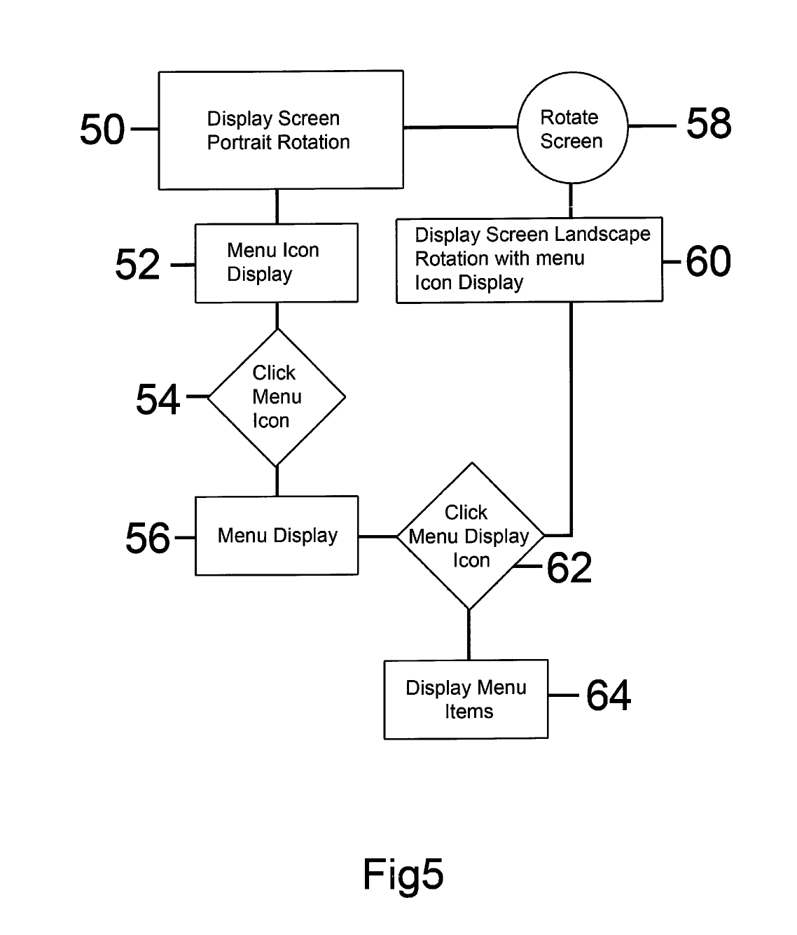

Referring to FIG. 5, the navigation system is for use in alternating menu displays in portrait and landscape viewing positions of a touch-enabled display screen computing unit that is capable of detecting a rotation function. The navigation system operates when computing device is placed into a portrait rotation position to provide a first display screen 50. The first display screen provides a menu icon 52 that can be clicked 54 for displaying a current menu 56 on the first display screen. Rotating of the computing device 58 into a landscape rotation position to provide a second display screen 60, displaying the current menu on the second display screen 60. From the current menu display 56 or second display screen 60, the user may click on an icon in the menu 62 to access a plurality of submenus 64 behind the current menu wherein the submenus 64 become the current menu.

The navigation system includes the step of identifying a rotation position of the computing device for selecting a portrait rotation position or a landscape rotation position. The current menu automatically displays only in the landscape rotation position.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A responsive graphical user navigation interface for use in alternating menu displays in portrait and landscape viewing positions of a computing unit capable of detecting a rotation function, said navigation system comprising placing said computing device into a portrait rotation position to provide a first display screen, said first display screen including a menu icon that can be clicked for displaying a current menu on said first display screen, and rotating said computing device into a landscape rotation position to provide a second display screen, displaying said current menu on said second display screen.

2. The responsive graphical user navigation interface for use in alternating menu displays according to claim 1 including the step of arranging a plurality of submenus behind said current menu wherein said submenus becomes the current menu.

3. The responsive graphical user navigation interface for use in alternating menu displays according to claim 1 including the step of identifying a rotation position of said computing device for selecting a portrait rotation position or a landscape rotation position.

4. The responsive graphical user navigation interface for use in alternating menu displays according to claim 1 wherein the display screen is a touch-enabled display screen.

5. The responsive graphical user navigation interface for use in alternating menu displays according to claim 1 wherein said current menu automatically displays only in the landscape rotation position.

6. The responsive graphical user navigation interface for use in alternating menu displays according to claim 1 wherein a set of computer program instructions stored in the memory of said computing device and executed by said computing device in order to perform actions of: calculating a portrait rotation position for placement of said menu icon on said display screen; and calculating a landscape rotation position for placement of said menu on said display screen, wherein the landscape rotation position is visually rotated from the portrait rotation position.

7. The responsive graphical user navigation interface for use in alternating menu displays according to claim 1 wherein said computing device identifies a rotation type and calculates an orientation as an absolute orientation in response to the rotation type, wherein the orientation is independent of the first orientation based upon rotating the computing device a fixed number of degrees.

8. The responsive graphical user navigation interface for use in alternating menu displays according to claim 6 wherein said computing device is using a Web Browser selected from the group of: Microsofts Internet Explorer, Google Chrome, Mozilla Firefox, Apple's Safari and Opera.

9. The responsive graphical user navigation interface for use in alternating menu displays according to claim 6 wherein said computing device is used on Apple IOS, Microsoft IOS, Blackberry IOS, Android IOS.

10. The responsive graphical user navigation interface for use in alternating menu displays according to claim 9 wherein said computing device is used on all versions of said IOS.
